(19) United States
(12) Patent Application Publication
(10) Pub. No.: US 2009/0113545 A1
(43) Pub. Date: Apr. 30, 2009

(54) Method and System for Tracking and Filtering Multimedia Data on a Network

(75) Inventors: Marc Pic, Paris (FR); David Fischer, Vaucresson (FR); Michel Navarre, Croissy Sur Seine (FR); Christophe Tilmont, Paris (FR)

Correspondence Address: WEINGARTEN, SCHURGIN, GAGNEBIN & LEBOVICI LLP, TEN POST OFFICE SQUARE, BOSTON, MA, 02109, US

(73) Assignee: ADVESTIGO, Saint Cloud (FR)

(21) Appl. No.: 11/922,192

(22) PCT Filed: Jun. 15, 2006
(86) PCT No.: PCT/FR2006/050605

§ 371 Date: Mar. 7, 2008

(30) Foreign Application Priority Data
Jun. 15, 2005 (FR) 0506089

(51) Int. Cl. G06F 21/00

(52) U.S. Cl. 726/22

(57) ABSTRACT

The method for identifying and filtering multimedia data consists of monitoring off-line, on a data transmission network, multimedia data with reference to reference multimedia data and using an on-line intervention module to intercept, query or listen to the multimedia data recognized on-line using formal data stored in a formal activation database generated during off-line monitoring using suspicious data obtained during a search for multimedia data on the network.

This invention concerns a method and a system for identifying and filtering multimedia data on a data transmission network.

It is known that a large number of illegal content exchanges are effected on networks such as the World Wide Web, in particular using peer-to-peer (P2P) exchanges and electronic marketplaces.

It is known to implement protocol filtering in order to identify users of the P2P protocol. However, the protocol filtered is not illegal in itself and therefore it is not possible to block such a protocol in its entirety, as it is possible to use it to transmit legal as well as illegal data.

It is also known to implement multimedia data intercepts on a network by using content recognition.

In order to implement intercepts by means of audio, video or image content recognition, however, it is not sufficient to rely on the exact signature identifications, such as those used with check-sum strategies or strategies that use hash functions such as the MD5 (Message Digest 5) signature algorithm. Indeed, the modification of a few bits in a music file, for example, can make a signature such as an MD5 signature ineffective, while the content of the modified file is still perfectly recognizable to the human ear and therefore usable.

Furthermore, a widespread method for exhaustive and systematic checks of all peer-to-peer transactions would be an extremely cumbersome mechanism from a technological point of view, if one were to filter all exchanges effected on a network.

The general filtering solutions already known essentially consist of blocking ports currently used for peer-to-peer exchanges, or detecting exchanges using such P2P protocols. However it is relatively easy to modify the deployment context of a P2P protocol, such as by changing the communications port to circumvent filtering. Furthermore, as indicated above, it is difficult to imagine an Internet access provider applying a filtering rule to all P2P protocols on account of the fact that it is not the protocol itself, but the way it is used in certain cases, that is illegal, and that perfectly legal content (for example software or source code that is copyright free) can be exchanged using this method.

There is therefore a need to implement identification and filtering of prohibited content on peer-to-peer networks (P2P) in an efficient but technologically simple manner, that does not have a negative impact on peer-to-peer exchanges of entirely legal content.

A system is already known from patent WO 02/082271 for detecting the unauthorized transmission of digital works over a data transmission network. However, this system is essentially based on probability and implements exclusively “on the fly” on-line monitoring measures.

There is also a need to identify and filter adverts for counterfeit products on electronic marketplaces.

Electronic marketplaces, such as on-line auction sites, make it possible to distribute counterfeit products without attracting the attention of police or customs services on account of the fragmented nature of their distribution. A retailer of such products located in a given country may register under different assumed identities and use this cover to market counterfeit products in small lots that are therefore difficult to track.

It is therefore necessary to be able to identify and filter such offers of counterfeit products in order for example to send warnings if messages with illegal content, such as adverts for counterfeit products, are detected.

The invention is therefore intended to resolve the problems mentioned above and to make it possible to recover and filter multimedia data from digital data transmission networks such as the Internet, in a manner that is both simple and efficient without making it necessary to filter all exchanges effected on the network.

According to the invention, these objectives are achieved using a method for identifying and filtering multimedia data on a data transmission network, characterized in that it includes the following stages:
a) monitoring off-line the multimedia data related to reference multimedia data, with the following stages:
   a1) calculating the original fingerprints of the reference multimedia data,
   a2) storing original reference fingerprints calculated in a fingerprint database,
   a3) searching for multimedia data on the network and downloading suspicious data,
   a4) calculating suspicious fingerprints of suspicious multimedia data,
   a5) checking suspicious fingerprints against original fingerprints and classifying suspicious fingerprints into classes of similar fingerprints,
   a6) generating formal data with priority allocation by fingerprint class and storing formal data in a formal activation database,
   a7) intermittently populating at least one on-line intervention module on the network with an at least partial copy of the formal activation database,
b) carrying out at least one of the following operations using the on-line intervention module:
   b1) intercepting on-line the multimedia data recognized using the formal data in the formal activation database and deciding whether to allow the multimedia data recognized to pass or to block it,
   b2) querying on-line the multimedia data recognized using the formal data in the formal activation database and at least recording or storing the multimedia data recognized, or triggering an alert when the multimedia data is recognized,
   b3) listening on-line to multimedia data recognized using the formal data in the formal activation database and at least recording or storing the multimedia data recognized, or triggering an alert when the multimedia data is recognized.

Advantageously, the formal activation data in the formal database is sorted and organized periodically, selecting the most important formal data on the basis of at least one priority criterion.

Preferably, during an on-line intercept, on-line listening or on-line query operation, the formal data stored in the formal activation database is updated periodically, using statistical data obtained during on-line intercept, on-line listening or on-line query operations.

According to an advantageous characteristic, following the search stage for multimedia data on the network and downloading of suspicious data, the suspicious multimedia data is filtered using at least one predetermined selection heading, and the suspicious fingerprints are only calculated for the suspicious multimedia data that meet the predetermined selection criterion.

According to a specific embodiment, said predetermined selection criterion includes at least one of the following selection elements for a file containing suspicious multimedia data: file type depending on the type of media it contains, state of corruption of the file, size of file content.

Advantageously, the original fingerprints of the reference multimedia data and the suspicious fingerprints of the suspicious multimedia data are calculated using the same method, but identifying suspicious fingerprints that have simplified characteristics compared to the original fingerprints.

According to another specific characteristic, the IP address from which network searches and downloads are effected is changed regularly in order to make the exchanges anonymous.

According to a specific embodiment, in order to intercept multimedia data on-line, data packets on the network are conditionally routed to an intercept module including a buffer stage to temporarily store an incoming data packet, a data-packet analysis stage and an activation stage to authorize the transmission of the data packet analysed or to reject it, and then to order the deletion of the packet in the buffer stage and the entry of the next packet into the analysis stage.

In this case, in the intercept module, the packets coming from the buffer stage are advantageously filtered before entering the analysis stage.

According to a specific characteristic, in the intercept module, the activation stage is also used to record statistical data regarding packets rejected or transmitted.

According to a specific embodiment of the invention, in order to perform the on-line query of multimedia data, the content of a web server or peer-to-peer server is queried or explored using requests, the data collected in response to these requests is compared with the data in the formal activation database and, depending on the result of the comparison, an alert is triggered, data is collected or no action is taken.

According to another specific embodiment of the invention, in order to listen to multimedia data on-line, within a proxy server, firstly client requests are listened to and the requests are copied along with the data collected in response to these requests, and secondly data is transmitted transparently between client and server, the data collected and copied is compared with the data in the formal activation database and, depending on the result of the comparison, an alert is triggered, data is collected or no action is taken.

In the embodiments above, the data collected is advantageously filtered before being compared with the data in the formal activation database.

According to a particular application of the method according to the invention, the stage that consists of searching for multimedia data on the network and downloading suspicious data is performed on peer-to-peer content to be exchanged, the formal data includes hash codes and the intercept or listening is effected from a listening point on the peer-to-peer network by retrieving in real time the hash codes of the data packets used in peer-to-peer exchanges.

The invention also includes a system for identifying and filtering multimedia data on a network, characterized in that it includes:
an off-line multimedia data monitoring module related to reference multimedia data, this off-line monitoring module including at least:
a calculation module for the original fingerprints of the reference multimedia data,
a storage module for the original reference fingerprints calculated,
a search module for multimedia data on the network,
a download module for suspicious information detected,
a calculation module for the suspicious fingerprints of the suspicious multimedia data downloaded,
a storage module for the suspicious fingerprints calculated,
a verification and classification module for suspicious fingerprints,
a module for generating formal data with priority allocation by fingerprint class, and
a storage module for the formal data constituting a formal activation database, and at least one of the following modules for on-line intervention on the network:

a) an on-line intercept module comprising at least
a local storage module for at least part of the formal activation database,
a buffer module,
a module for analysis and comparison of the data supplied by the buffer module with the data stored in the local storage module,
an activation module that reacts to the data supplied by the analysis module, and
a selective transmission module for the multimedia data recognized, activated by the activation module,

b) an on-line query module comprising at least:
a local storage module for at least part of the formal activation database,
a request module to supply the data collected in response to requests,
a module for analysis and comparison of said response data collected with the data stored in the local storage module,
an activation module that reacts to the data supplied by the analysis module, and
an alert, recording or storage module for the multimedia data recognized, activated by the activation module,

c) an on-line listening module comprising at least:
a local storage module for at least part of the formal activation database,
a proxy server for listening to client requests and copying the requests and data collected in response to the requests,
a module for analysis and comparison of said response data collected with the data stored in the local storage module,
an activation module that reacts to the data supplied by the analysis module,
an alert, recording or storage module for the multimedia data recognized, activated by the activation module.

According to a specific characteristic, the on-line intercept module also includes an alert, recording or storage module for the multimedia data recognized, activated by the activation module.

Advantageously, the off-line monitoring module also includes a periodic reorganization module for the formal activation data in the formal database.

According to a specific embodiment, the on-line intercept module, the on-line query module and the on-line listening module also each include a filtering module located at the input of the analysis module.

In general, the invention applies to the identification and filtering of digital multimedia data that may be images, text, audio signals, video signals or a combination of these different content types.

Other characteristics and advantages of the invention will arise from the following description of the specific embodiments, given as examples, in reference to the drawings attached, in which:

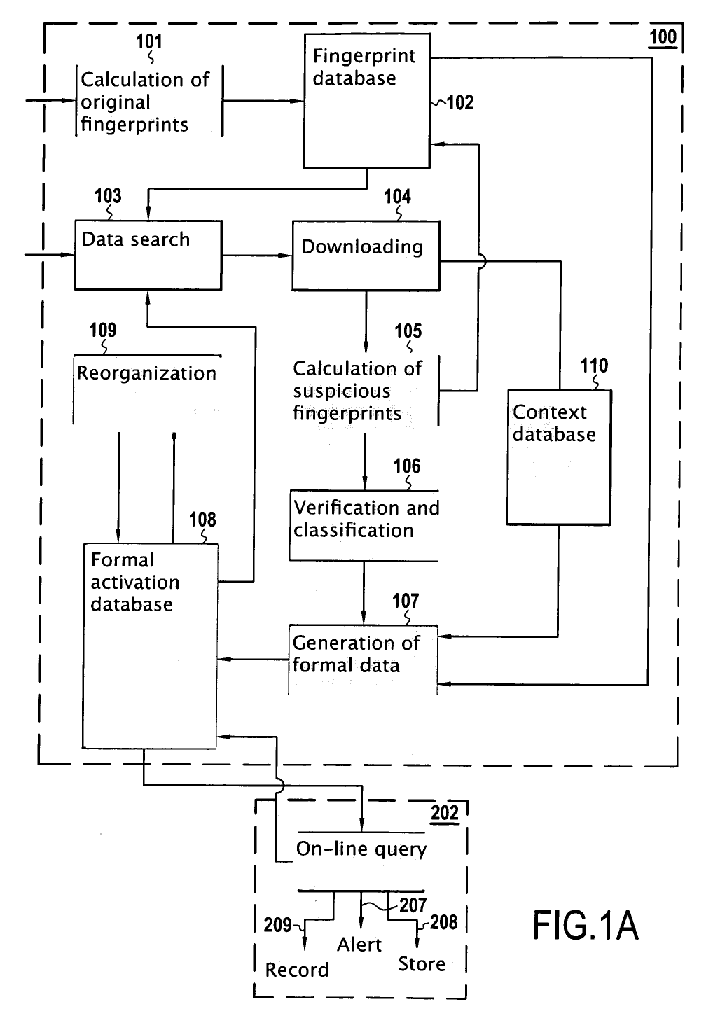

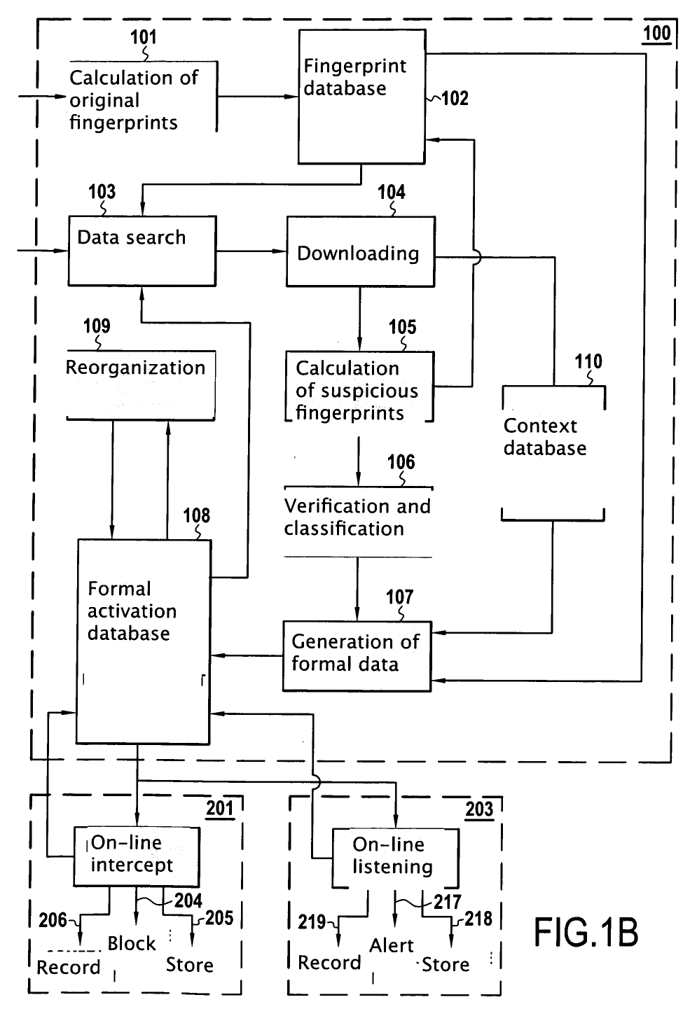

FIGS. 1A and 1B are block diagrams of the principal constituent parts of an example system according to the invention to identify and filter multimedia data on a network, for on-line query and on-line intercept or on-line listening applications respectively.

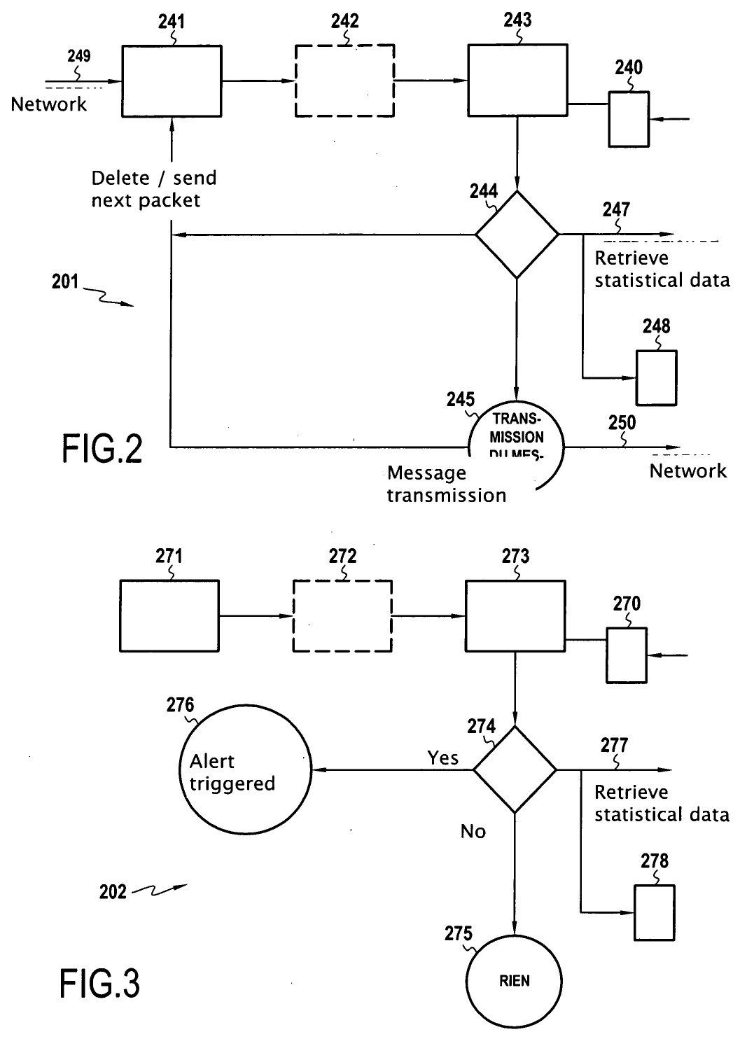

FIG. 2 is a block diagram showing an example embodiment of the on-line intercept module useable in the system in FIG. 1B,

FIG. 3 is a block diagram showing an example embodiment of the on-line query module useable in the system in FIG. 1A,

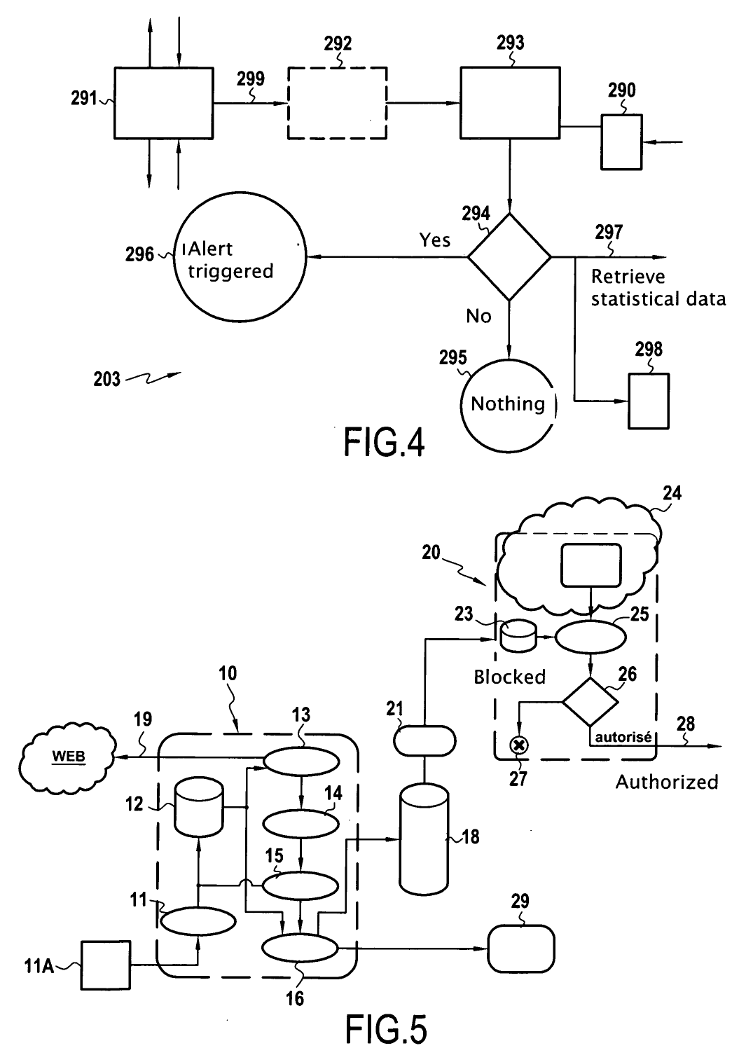

FIG. 4 is a block diagram showing an example embodiment of the on-line listening module useable in the system in FIG. 1B,

FIG. 5 is a block diagram showing an example application of the invention for identifying and filtering adverts for counterfeit products in electronic marketplaces,

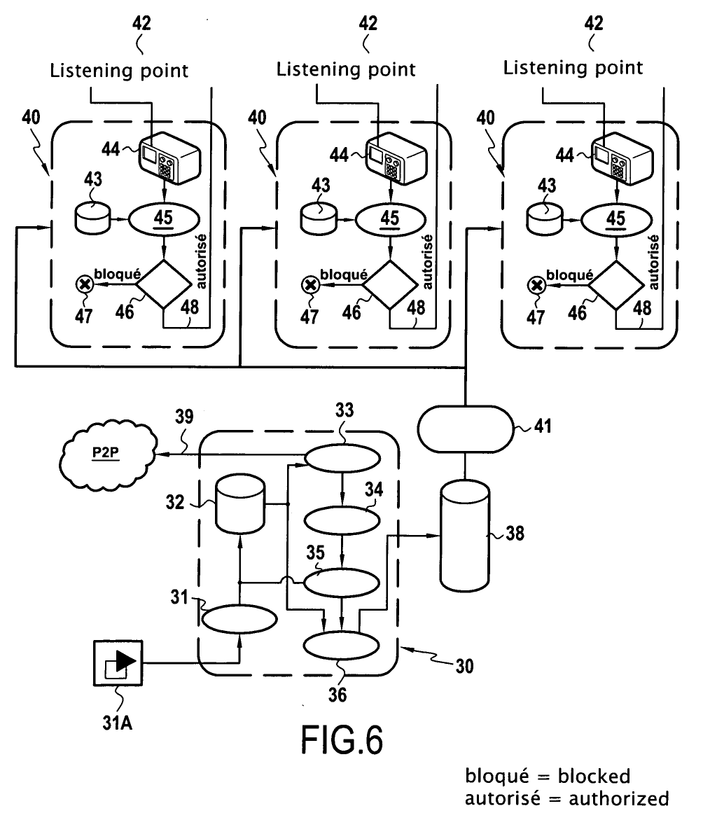

FIG. 6 is a block diagram showing an example application of the invention for identifying and filtering prohibited content on peer-to-peer networks.

A general description, with reference to FIGS. 1A and 1B, is first provided for the method and the system according to the invention for identifying and filtering multimedia data on a digital data transmission network, such as the Internet, which may make use of either web servers or peer-to-peer (P2P) servers.

The invention implements on the one hand a first off-line, i.e. with no time constraints, monitoring module 100 for multimedia data related to the reference multimedia data and on the other hand one or more remote on-line intervention modules 201, 202, 203 on the network, i.e. working in real time.

According to the invention, in the off-line monitoring module 100, a first stage consists, on the basis of original documents being protected, for example because they are covered by copyrights or intellectual property rights, of calculating the approximate fingerprint of these original reference documents (module 101). These calculated original fingerprints are then stored in a fingerprint database 102.

To characterize the original multimedia documents using approximate fingerprints, a range of indexing and identification methods can be used, such as the method described in patent application FR 2 863 080 which provides several examples covering the different types of media that may appear independently or in combination within a document sent over a digital data transmission network: audio, video, still images, text.

In another stage of the method according to the invention implemented in the off-line monitoring module 100, the multimedia data on the network is searched (module 103) and suspicious data identified using the information supplied to the search module 103 by the fingerprint database 102 is downloaded.

The search module 103 then searches the multimedia data on the network using server queries on web servers or peer-to-peer servers. This query is effected using requests generated automatically by the system in the search module 103.

The system can then initially extract keywords from the data contained in the list of original fingerprints in the fingerprint database 102: extraction of words from headers, related data, context, content type, etc.

These keywords are filtered by relevance and rarity using frequency dictionaries. The remaining keywords are then associated using different direct combinations to generate requests.

Different strategies may be used, depending on context, to find suspicious content on the network, using the data search module 103.

Within the context of peer-to-peer networks, in which each terminal is configured to act as both server and client thus allowing two terminals in a P2P network to exchange files without going through a central data-distribution server, the system according to the invention uses the general requests in the search module 103 to query servers using different P2P protocols to obtain access to the content provided by the parties.

The P2P servers return to the module 103 the different access options characterized by unique identifiers provided by a P2P server.

The search module 103 then eliminates the options that do not meet the requirements of the enquiry by filtering certain keywords or certain document types (files ending .exe could be rejected, for example).

Optionally, by querying the formal activation database 108, which is described below, the search module 103, in consideration of the formal data already established, may eliminate the options that provide formal data that is identical to the data already in the formal database 108.

The search module 103 can then find Internet-user machines offering suspicious content corresponding in full or in part to the original reference documents.

In module 104, suspicious content is downloaded in full or in part, and in any case in sufficient quantity to enable the content to be recognized using the mechanisms for producing and checking suspicious fingerprints, described below with reference to modules 105 to 107.

In the case of the context of a network such as the web, the search module 103 explores the web servers defined in the targets.

Optionally, the search module 103 may first query the reference web servers to automatically determine the links to the web servers sought. These target servers are queried using requests produced in the same way as for P2P.

The web servers identified in the targets are explored by downloading a web page, analysing the content of that page, finding the links included in it, filtering these links using certain criteria, downloading the pages corresponding to these links and so on recursively until a stop condition is fulfilled, such as number of pages accessed or depth of penetration in a site tree. Web pages are downloaded with all of their related content (image, sound, video, files, etc.) or with just some of these media types.

Links in pages may be filtered using “a priori” knowledge of the site. For example, links to adverts that are known to appear in a particular form or syntax can be eliminated from the search on the basis of these criteria.

It is therefore possible to activate exploration of a site not on the homepage, which is searched exhaustively and recursively, but instead program a specific exploration route that is able to extract only specific data from the site. For example, a site providing lists of responses arranged with a useable link and decorative links (images, summaries, etc.) for each response can be used by defining precise syntactic analysis rules as exploration routes that only retain tags with useable links and reject all others.

Navigation between several pages may also be automated by combining syntactic rules to determine whether a link is worth exploring or not, and navigation rules that determine how to get to a particular page mentioned in a link even if the link does not lead directly to that page.

Such navigation rules also make it possible to program navigation routes to links that are not mentioned in the document but that can be determined by interpolation. For example, if two links in a page mention pages called index2.html and index4.html, advantageously the page index3.html can also be searched for.

When downloading content (pages or files), all of the context of these downloads is kept in a database, called the context database, which is shown in FIGS. 1A and 1B.

Suspicious documents downloaded using the methods detailed above are advantageously selected using an initial filter to determine whether they are worth processing using the fingerprint verification method.

Different types of selection criteria can be used and may include for example:
media type (such as image),
the state of the file (corrupted file, for example),
data within the file (size of content and conditions determining for example that small images less than 5×5 pixels are not checked by fingerprint technologies),
data calculated using prior data (such as criteria determining that an image height to width ratio greater than 20 means that it is a divider or a decorative element).

Files downloaded and retained following the optional filtering stage described above are subject to fingerprint calculation in the module 105, using the same technology as that used to calculate original fingerprints in the module 101 stage.

Suspicious fingerprints of suspicious documents downloaded and retained may therefore be calculated using techniques described in the aforementioned French patent application 2 863 080.

If it is necessary to use the same technology as used to calculate the original fingerprints in order to calculate suspicious fingerprints, a more complex fingerprint may be used for the original reference document and a simplified fingerprint for the downloaded suspicious document. This is because, if part of the suspicious fingerprint corresponds to the original fingerprint, this is enough to determine that it is a partial copy and therefore plagiarism.

Suspicious fingerprints calculated are checked against original fingerprints and classified with other similar fingerprints. The use of formal characteristics (title, hash code, connection identifier, etc.) related to the content makes it possible to extend classes already created on the basis of fingerprint similarity alone.

Suspicious fingerprints are stored in a fingerprint database which may for example be combined with the fingerprint database 102 containing the original fingerprints.

Suspicious fingerprints may be checked and compared using for example the technologies described in patent application FR 2 863 080 or other methods such as using a comparison distance between content.

As indicated above, when downloading content in the form of pages or files, all of the context of these downloads is kept in a database 110 called the context database.

This database 110 is run in the module 107 to determine a representation in the form of formal data of the content validated by the verification stage of the module 106.

For each content validation, a set of selected formal data, that already exists or is calculated, is retrieved, for example size, hash code, title, user connection identifier, keywords, distribution location, content domain, etc.

The nature of this formal data may be defined a priori by the system. For example, in the case of a search in a peer-to-peer context, size and hash code are two data elements that enable almost perfect identification of content. In another example, when searching web pages on a dedicated site that include content put on sale by a given user, the identifier of this user combined with a local object number may be an excellent content identifier.

The nature of formal data may also be determined using a learning mechanism. For example, a neural-network mechanism may receive at the input a vector compiling all of the formal data characterizing the content and have an output value dictated during a supervised learning stage to enable it to classify this content using characteristics in predefined classes (such as stolen goods, handling of stolen goods, copies, counterfeits, etc.). This action can be repeated until the mechanism learns the relationship between certain characteristics and is able, when presented with new content, to work out what category to place it in.

The formal data related to suspicious content is arranged in a database 108 with an identifier making it possible to retrieve this suspicious content and the original content to which it corresponds.

A permanent reorganization module 109 is advantageously linked to the formal activation database 108.

It is in fact beneficial for certain content to be given a higher priority than other content if this content corresponds to elements that are more critical for different reasons that make it possible to determine criticality criteria. The following criticality criteria are given as an example:
period criticality: for example, disclosing a film before its release in cinemas,
form criticality: for example, if there is a high-quality version that could replace a DVD,
content danger: if the content is prohibited, for example related to paedophilia,
content frequency: if there is a widely distributed variant.

Reorganizing the formal database 108, using the module 109, involves a selection that can be effected for example using a process that highlights priorities.

Each content is allocated a value depending on the criticality table, this table comprising columns, each of which represents one of the properties to be taken into consideration, and lines, each of which represents one content. At the intersection of line and column, a rating indicates the level of criticality, for example between 1 and 100. A content is classified by the product of its different ratings.

Other methods may be used for this organization, which may be repeated permanently, depending on the new data sent to the database 108, some of which comes from the on-line intervention modules described below.

In general, each rating to be used for a selection may be calculated automatically following recognition of the content in the module 106 for checking and classifying data supplied during registration of the original documents, as well as events measured during on-line intervention.

As an example, content frequency is a measured event: if the file has been seen several times during a period of time, its frequency increases.

The content danger criterion is based on content recognition: thus, paedophiliac content is classed as such in the database of original documents (fingerprint database 102).

Period criticality may arise from a combination of several factors. So, recognition of a particular film is included in the database of original documents and the release date of this film is also included in the database. On a given day, the fact that this film will not be released in cinemas for another two weeks means that there is period criticality, and this film should not be available before its cinema release.

As the content is classified in the formal database 108 by criticality, an adjustable threshold makes it possible to determine the maximum criticality values beyond which the content should be processed. Only the formal content data selected using this mechanism is sent to the on-line intervention modules, described below.

FIGS. 1A and 1B show a link between the fingerprint database 102 and the formal-data production module 107. However, this link is optional and cannot be used in all applications.

At least one on-line intervention module 202 (FIG. 1A) or 201, 203 (FIG. 1B) is intermittently populated, once a day for example (although this frequency may be adapted to requirements and resources and need not be regular) with an at least partial copy of the formal activation database, this copy containing the formal data corresponding to the content classified as priority.

An on-line intervention module on the data transmission network may intercept, block, record or analyse content routed on P2P networks or published on websites.

FIG. 1B shows a schematic representation of an on-line intercept module 201 that enables the selective blocking 204 of content, with the option where necessary of recording 206 and/or storing 205 the data blocked.

The on-line query module 202 shown in FIG. 1A makes it possible to trigger an alert 207 if suspicious content is detected in response to a request and may also record 209 and/or store 208 suspicious multimedia data recognized using the formal data related to this data.

The on-line listening module 203 shown in FIG. 1B makes it possible to passively detect suspicious content identified using the formal data associated with this content, and in the same way to trigger an alert 217, and if necessary to record 219 and/or store 218 suspicious data recognized.

The fact of using the formal database 108, duplicated at least in part in each on-line intervention module 201, 202, 203, instead of the fingerprint database 102, makes it possible to significantly speed up processing and to install only a small part of the technical means of the system as a whole in the query, intercept or listening device, this small part of the technical means also being easily adaptable to accommodate external formal criteria defined arbitrarily by system users. Thus, for example, a user may decide that only those packets in exchanges greater than a given minimum volume should be processed, all others being deemed to be harmless.

FIG. 2 shows an example embodiment of an on-line intercept module 201 that is placed in a data transmission network to conditionally and proportionately route data packets transmitted on the network between its input 249 and its output 250. Module 201 is also designed to record data.

Specifically, module 201 includes a local storage module 240 containing at least part of the formal data in the formal activation database 108.

A buffer module 241 is used to temporarily hold incoming data packets. The packets coming from the buffer module 241 are advantageously filtered by an optional filtering module 242 that makes it possible to preselect certain packets using a filtering rule, for example to implement a protocol filter.

The packets coming from the buffer module 241 that have not been eliminated by the filtering module 242 are sent to a module 243 for analysis and comparison of the data taken from the network via the buffer module 241 with the data stored in the local storage module.

An activation module 244 reacts to the data supplied by the analysis module 243 to decide whether or not to authorize transmission of the message taken from the network, via the selective transmission module 245 activated by the activation module 244, to the output 250 of the module 201 connected to the network.

Within the analysis module, a byte string taken from the data packet analysed is compared with the reference strings taken from the formal data stored in the local storage module 240.

If a byte string is recognized, the activation module 244 sends to the buffer module 241 a signal to delete the content that has been processed and requests transmission of the following packet. This signal is confirmed if the message is sent by the selective transmission module 245 once acknowledgement of correct transmission and receipt of the message is given.

The activation module 244 also makes it possible to order the storage of messages intercepted in a memory 248 and to collect from a line 247 a given quantity of data, in particular statistical data, for example regarding the nature of the packets in transit, the protocols used or the most common content. This data may have an influence on the hierarchy of the formal data in the formal database 108. Furthermore, this statistical data may be resent to the formal database 108 periodically (for example every one or two weeks) or when there is enough of it.

FIG. 3 shows an example of the on-line query module 202.

Module 202 makes it possible to query or explore the content of a web server or a peer-to-peer server using requests prepared in a request module 271 using data corresponding to the original documents, or by specific external populating.

The data collected on the network by the request module 271 in response to formal requests is sent when necessary via a filtering module 272 similar to the filtering module 242 to an analysis module 273 that effects a comparison of this collected data and the formal data stored in the local storage module 270 of at least part of the formal activation database 108.

An activation module 274 reacts to the results of the comparisons carried out in the analysis module 273 to order, as appropriate, triggering of an alert 276, storage of the data collected in a memory 278, retrieval of statistical data that can be sent on a line 277 to the formal database 108, or to order no action to be taken (action 275 in FIG. 3).

As an example, in the case of detection of the receipt of stolen goods on-line, it is possible to detect the stolen content received by recognizing the formal criteria or data taken from the formal database 108. The formal data is a collection of correlated data used to generate a decision and it may in this case include for example a user identifier, country of origin and price.

The alert triggered in the alert module 276 may take a range of forms such as sending an e-mail or SMS message, displaying information on an on-line site, or using a special tool for preventing piracy, such as an offer invalidation or locking mechanism.

The statistical data retrieved may be sent to a specific database that may provide for several applications such as calculation of the division of fees paid to the rightful owners.

The data stored in the memory 278 (as in the memory 248) may for example be focused on a single content provider in order to prepare an inventory of the actions regarding this distributer. This data may be stored and time-stamped using an automated document archiving service for later use.

FIG. 4 shows an example of the on-line listening module 203. Such a module may include the modules or elements 290 and 292 to 298 which are similar to the modules or elements 270 and 272 to 278 described above with reference to FIG. 3. Accordingly, these modules will not be described again.

The on-line listening module 203, which is an entirely passive module, also includes a proxy server 291 for listening to client requests and copying the requests and data collected in response to the requests.

The proxy server 291, which may be used in a P2P context or a web context, ensures transparent transmission between the client and server, but sends to the input 299 of the analysis module 293, or the filtering module 292 if there is one, a copy of the client requests and the responses to these requests, which have been routed via this proxy server 291.

The method and system for identifying and filtering multimedia data by separating formal data may take various different forms.

In particular, in the off-line monitoring module 100, it may be beneficial to regularly change the IP address from which network searches and downloads are effected, in order to keep the exchanges anonymous.

The description below in reference to FIG. 5 is a specific example of application of this invention for identifying and filtering adverts for counterfeit products in electronic marketplaces.

Electronic marketplaces make it possible to fragment distribution of counterfeit products, which may be offered for sale in small lots by a single retailer registered under different assumed identities.

The system shown in FIG. 5 in particular makes it possible to resolve this problem and make the sale of counterfeit products in small lots identifiable.

In FIG. 5, reference 10 refers to an off-line monitoring module that is approximately similar to the monitoring module 100 in FIGS. 1A and 1B.

The original documents 11A may consist for example of a brand, a design, a model or a brochure susceptible to counterfeiting.

Module 11 calculates the original fingerprints of the original documents 11A as detailed above in reference to FIGS. 1A and 1B. These original fingerprints are stored in a fingerprint database 12 that can be accessed by a search module 13 which carries out a monitoring search on the Internet (web) 19 covering a large number of documents, such as brochures, and the information they contain.

The module 13 for searching for adverts or similar documents cooperates with a module 14 for downloading the data collected by the search module 13.

A module 15 for calculating suspicious fingerprints makes it possible to calculate the fingerprints of suspicious documents collected and downloaded. These suspicious fingerprints are stored in a fingerprint database which may be combined with the fingerprint database 12 containing the original fingerprints. The fingerprint database 12 can therefore bring together all of the original fingerprints and suspicious fingerprints, for example by grouping them by virtual user.

The module 16 uses the suspicious fingerprints and the original fingerprints to compare and check these fingerprints with a group of adverts related to these fingerprints in order to classify them into equivalence classes by similarity with other fingerprints.

These equivalence classes make it possible to use a transitive analysis to work out the formal characteristics of the adverts (such as user identifier, distribution location, factual elements in brochure text or keywords) that may correspond to probable counterfeits. This task is performed by a module for generating formal data that in FIG. 5 is combined with module 16. The formal data is stored in a formal database 18 which is a database of factual identifiers of content distributed illegally, hierarchically classified by order of importance as described above in reference to FIGS. 1A and 1B.

A module 21 related to the formal database 18 ensures the regular transmission to an on-line intervention module 20 of a part of the formal database 18 to create a local copy 23 of this formal database.

The on-line intervention module 20 is active permanently and automatically detects new adverts in the module 24. These new adverts, in an analysis module 25, are subject to verification of the formal data that they include, in comparison with the formal data contained in the formal database 23. An activation module 26, then decides, depending on the result of the analysis, whether to retain a new advert detected on the network, if this new advert includes a sufficient quantity of formal data that corresponds to the formal data stored in the database 23. If not, the advert continues its route on the network using line 28.

If an advert has been retained, it may be blocked as indicated by the tag 27, or may simply trigger an alert. The alert may for example consist of sending a warning (sent by the module 29, controlled by the verification and classification module 16).

The monitoring module 10, and the formal database 18 work off-line on adverts already published as well as advert histories, while the on-line intervention module 20 that is permanently active automatically detects new adverts and accepts or rejects them immediately as appropriate.

A permanent reorganization module may be associated with the formal database 18, as described in reference to FIGS. 1A and 1B.

The module 21 regularly sends formal data that has become more important in the hierarchy to the local copy 23.

FIG. 6 shows a specific application of the invention for identifying and filtering prohibited content on peer-to-peer networks.

Peer-to-peer file exchange protocols allow users who do not know each other to share files using declaratory information on the content of the file. A user (uploader or server) makes content available on the network at the user address. Anyone searching for this type of content queries one of these servers, finds the information and sends a download request to the address of the first party. File sharing now starts.

Many of these exchanges are barely legal. Content covered by copyright or related rights are quickly distributed between parties, propagating exponentially, regardless of copyright law.

The system according to the invention makes it possible to resolve this problem by filtering the content routed through a crossing point making it possible to determine whether the content involved in a P2P exchange is being shared legally or whether it infringes copyright law.

Such content detection would be difficult to undertake in a detailed content study on account of the operating constraints of the intercept point. Indeed, the useable crossing points, such as operator broadband access servers (BAS) or access-provider receivers (LNR), are dimensioned to use rates often around one gigabit per second. Such rates make it difficult to set up detection solutions that include on-the-fly calculation of fingerprints of the data packets exchanged, followed by recognition of this content in a fingerprint database of original documents representing the copyrights for which protection is sought, which may amount to several hundred thousand documents.

According to the invention, thanks to the separation of intelligent recognition of content using fingerprints in a monitoring module 30, and characterization of content using formal data that enables on-line intervention in real time using on-line intervention modules 40, prohibited content may be identified and filtered simply and reliably on P2P networks despite the large quantity of documents concerned.

It is beneficial to use protocol hash codes as the formal data. These hash codes are signatures calculated using one-way hash functions provided by P2P exchange protocols. These hash codes are used by the protocols to ensure the integrity, validity and compatibility of the pieces of content exchanged by parties. These hash codes are calculated using the client software of the peer-to-peer exchange and are included in the exchanges both in requests and responses.

These hash codes are also placed in the first header blocks of the packets exchanged, which makes it easier to detect them.

In FIG. 6, the module 31 calculates the original fingerprints using the original documents to be protected 31A. These original fingerprints are stored in an original fingerprint database 32 that can be accessed by a module 33 for searching the P2P protocols available on the network 39.

The search module 33 searches and observes the P2P content to be exchanged and cooperates with a download module 34 which transfers the content collected to a module 35 for calculating suspicious fingerprints. The verification and classification module 36 uses the fingerprints calculated to group the content downloaded and the corresponding hash codes and characterizes them in relation to the original content provided by the rightful owners.

Module 36 also includes a module for generating formal data, which sorts the most interesting hash codes (those that represent the most dangerous exchanges) and provides these hash codes as formal data to a formal database 38 which then includes the hash codes of illegally distributed content with their hierarchical classification.

A module 41 ensures the regular transmission (for example daily) of the best formal data in the formal database 38, that is the most important formal data in the hierarchy, to the local copies 43 of at least part of the formal database 38.

In each on-line intervention module 40 on the network, at a listening point 42, there is a device 44 for capturing data from the network and the buffer module function to retrieve formal data in real time, including the protocol hash codes of the P2P data packets.

The module 30 that calculates fingerprints searches or observes the P2P networks without any time constraint while the on-line intervention modules 40 detect the formal data (hash codes) in real time in the data packets routed via the crossing point 42 selected.

Within a module 40, an analysis module 45 cooperates with the local copy 43 of the formal database 38 and with the device 44 capturing data from the P2P network in a buffer module, to detect data packet headers and to analyse and check the hash code against the hash codes already stored in the local copy 43.

Depending on the result of this analysis, an activation module 46 decides whether to block a data packet deemed to have illegal content (tag 47) or to allow it to return to the network (tag 48).

Naturally, in the simplified example given above, as in the general case described with reference to FIGS. 1A and 1B, the intervention module on the network, which comprises an on-line intercept module 60, may be replaced or completed if required by an on-line query module or an on-line listening module.

In general, according to the applications envisaged, the module 100 for the off-line monitoring of multimedia data related to reference multimedia data may cooperate with a single on-line intervention module selected from the on-line query module 202, the on-line intercept module 201 and the on-line listening module 203, or simultaneously with any two of these different on-line intervention modules, or even simultaneously with all of these three types of on-line intervention module 201, 202, 203.

1. Method for identifying and filtering multimedia data on a data transmission network, characterized in that it includes the following stages:
a) monitoring off-line the multimedia data related to reference multimedia data, with the following stages:
a1) calculating the original fingerprints of the reference multimedia data,
a2) storing original reference fingerprints calculated in a fingerprint database,
a3) searching for multimedia data on the network and downloading suspicious data,
a4) calculating suspicious fingerprints of suspicious multimedia data,
a5) checking suspicious fingerprints against original fingerprints and classifying suspicious fingerprints into classes of similar fingerprints,
a6) generating formal data with priority allocation by fingerprint class and storing formal data in a formal activation database,
a7) intermittently populating at least one on-line intervention module on the network with an at least partial copy of the formal activation database,
b) carrying out at least one of the following operations using said on-line intervention module:
b1) intercepting on-line the multimedia data recognized using the formal data in the formal activation database and deciding whether to allow the multimedia data recognized to pass or to block it,
b2) querying on-line the multimedia data recognized using the formal data in the formal activation database and at least recording or storing the multimedia data recognized, or triggering an alert when the multimedia data is recognized,
b3) listening on-line to multimedia data recognized using the formal data in the formal activation database and at least recording or storing the multimedia data recognized, or triggering an alert when the multimedia data is recognized.

2. Method according to claim 1, characterized in that the formal activation data in the formal database is sorted and organized periodically, selecting the most important formal data on the basis of at least one priority criterion.

3. Method according to claim 1, characterized in that, during an on-line intercept, on-line listening or on-line query operation, the formal data stored in the formal activation database is updated periodically, using statistical data obtained during on-line intercept, on-line listening or on-line query operations.

4. Method according to claim 1, characterized in that, following the search stage for multimedia data on the network and downloading of suspicious data, the suspicious multimedia data is filtered using at least one predetermined selection heading, and the suspicious fingerprints are only calculated for the suspicious multimedia data that meet said predetermined selection criterion.

5. Method according to claim 4, characterized in that said predetermined selection criterion includes at least one of the following selection elements for a file containing suspicious multimedia data: file type depending on the type of media it contains, state of corruption of the file, size of file content.

6. Method according to claim 1, characterized in that the original fingerprints of the reference multimedia data and the suspicious fingerprints of the suspicious multimedia data are calculated using the same method, but identifying suspicious fingerprints that have simplified characteristics compared to the original fingerprints.

7. Method according to claim 1, characterized in that the IP address from which network searches and downloads are effected is changed regularly in order to make the exchanges anonymous.

8. Method according to claim 1, characterized in that in order to intercept multimedia data on-line, data packets on the network are conditionally routed to an intercept module including a buffer stage to temporarily store an incoming data packet, a data-packet analysis stage and an activation stage to authorize the transmission of the data packet analysed or to reject it, and then to order the deletion of the packet in the buffer stage and the entry of the next packet into the analysis stage.

9. Method according to claim 8, characterized in that in the intercept module, the packets coming from the buffer stage are filtered before entering the analysis stage.

10. Method according to claim 8, characterized in that in the intercept module, the activation stage is also used to record statistical data regarding packets rejected or transmitted.

11. Method according to claim 1, characterized in that in order to perform the on-line query of multimedia data, the content of a web server or peer-to-peer server is queried or explored using requests, the data collected in response to these requests is compared with the data in the formal activation database and, depending on the result of the comparison, an alert is triggered, data is collected or no action is taken.

12. Method according to claim 1, characterized in that in order to listen to multimedia data on-line, within a proxy server, firstly client requests are listened to and the requests are copied along with the data collected in response to these requests, and secondly data is transmitted transparently between client and server, the data collected and copied is compared with the data in the formal activation database and, depending on the result of the comparison, an alert is triggered, data is collected or no action is taken.

13. Method according to claim 11, characterized in that the data collected is filtered before being compared with the data in the formal activation database.

14. Method according to claim 1, characterized in that the stage that consists of searching for multimedia data on the network and downloading suspicious data is performed on peer-to-peer content to be exchanged, in that the formal data includes hash codes and in that the intercept or listening is effected from a listening point on the peer-to-peer network by retrieving in real time the hash codes of the data packets used in peer-to-peer exchanges.

15. System for identifying and filtering multimedia data on a network, characterized in that it includes:
an off-line multimedia data monitoring module related to reference multimedia data, this off-line monitoring module including at least:
a calculation module for the original fingerprints of the reference multimedia data,
a storage module for the original reference fingerprints calculated,
a search module for multimedia data on the network,
a download module for suspicious information detected,
a calculation module for the suspicious fingerprints of the suspicious multimedia data downloaded,
a storage module for the suspicious fingerprints calculated,
a verification and classification module for suspicious fingerprints,
a module for generating formal data with priority allocation by fingerprint class, and
a storage module for the formal characteristics constituting a formal activation database, and at least one of the following modules for on-line intervention on the network:
a) an on-line intercept module comprising at least
a local storage module for at least part of the formal activation database,
a buffer module,
a module for analysis and comparison of the data supplied by the buffer module with the data stored in the local storage module,
an activation module that reacts to the data supplied by the analysis module, and
a selective transmission module for the multimedia data recognized, activated by the activation module,
b) an on-line query module comprising at least:
a local storage module for at least part of the formal activation database,
a request module to supply the data collected in response to requests,
a module for analysis and comparison of said response data collected with the data stored in the local storage module,
an activation module that reacts to the data supplied by the analysis module,
an alert, recording or storage module for the multimedia data recognized, activated by the activation module,
c) an on-line listening module comprising at least:
a local storage module for at least part of the formal activation database,
a proxy server for listening to client requests and copying the requests and data collected in response to the requests,
a module for analysis and comparison of said response data collected with the data stored in the local storage module,
an activation module that reacts to the data supplied by the analysis module,
an alert, recording or storage module for the multimedia data recognized, activated by the activation module.

16. System according to claim 15, characterized in that the on-line intercept module also includes an alert, recording or storage module for the multimedia data recognized, activated by the activation module.

17. System according to claim 15, characterized in that the off-line monitoring module also includes a periodic reorganization module for the formal activation data in the formal database.

18. System according to claim 15, characterized in that the on-line intercept module, the on-line query module and the on-line listening module also each include a filtering module located at the input of the analysis module.

19. Method according to claim 3, characterized in that:
following the search stage for multimedia data on the network and downloading of suspicious data, the suspicious multimedia data is filtered using at least one predetermined selection heading, and the suspicious fingerprints are only calculated for the suspicious multimedia data that meet said predetermined selection criterion;
said predetermined selection criterion includes at least one of the following selection elements for a file containing suspicious multimedia data: file type depending on the type of media it contains, state of corruption of the file, size of file content;
the original fingerprints of the reference multimedia data and the suspicious fingerprints of the suspicious multimedia data are calculated using the same method, but identifying suspicious fingerprints that have simplified characteristics compared to the original fingerprints;
the IP address from which network searches and downloads are effected is changed regularly in order to make the exchanges anonymous.

20. Method according to claim 19, characterized in that in order to intercept multimedia data on-line, data packets on the network are conditionally routed to an intercept module including a buffer stage to temporarily store an incoming data packet, a data-packet analysis stage and an activation stage to authorize the transmission of the data packet analysed or to reject it, and then to order the deletion of the packet in the buffer stage and the entry of the next packet into the analysis stage.

21. Method according to claim 19, characterized in that in order to perform the on-line query of multimedia data, the content of a web server or peer-to-peer server is queried or explored using requests, the data collected in response to these requests is compared with the data in the formal activation database and, depending on the result of the comparison, an alert is triggered, data is collected or no action is taken.

22. Method according to claim 19, characterized in that in order to listen to multimedia data on-line, within a proxy server, firstly client requests are listened to and the requests are copied along with the data collected in response to these requests, and secondly data is transmitted transparently between client and server, the data collected and copied is compared with the data in the formal activation database and, depending on the result of the comparison, an alert is triggered, data is collected or no action is taken.

23. System according to claim 16, characterized in that
the off-line monitoring module also includes a periodic reorganization module for the formal activation data in the formal database;
the on-line intercept module, the on-line query module and the on-line listening module also each include a filtering module located at the input of the analysis module.
